(19) United States
(12) Patent Application Publication
(10) Pub. No.: US 2026/0134271 A1
(43) Pub. Date: May 14, 2026

(54) SPARSITY MASK LEARNING USING A TOP-K ESTIMATOR

(71) Applicant: Google LLC, Mountain View, CA (US)

(72) Inventors: Ganesh Jawahar, Mountain View, CA (US); David Qiu, Fremont, CA (US); Shaojin Ding, San Jose, CA (US); Xingyu Cai, San Jose, CA (US); Antoine Jean Bruguier, Milpitas, CA (US); Steven M. Hernandez, San Jose, CA (US); Shivani Agrawal, Sunnyvale, CA (US); Yanzhang He, Mountain View, CA (US)

(73) Assignee: Google LLC, Mountain View, CA (US)

(21) Appl. No.: 19/351,202

(22) Filed: Oct. 6, 2025

Related U.S. Application Data
(60) Provisional application No. 63/719,189, filed on Nov. 12, 2024.

(51) Int. Cl. G06N 3/0495; G06N 3/08

(52) U.S. Cl. CPC G06N 3/0495; G06N 3/08

(57) ABSTRACT

A method includes obtaining a plurality of training samples each including a corresponding input and a corresponding ground-truth output. The method also includes obtaining a plurality of model weights and a plurality of mask weights of a machine learning (ML) model, determining a sparsity mask based on the plurality of mask weights and generating a plurality of masked model weights by applying the sparsity mask to the model weights. For each training sample, the method also includes processing, using the ML model based on the plurality of masked model weights, the corresponding input to generate a predicted output, and determining a corresponding loss based on the corresponding ground-truth output and the predicted output. The method also include updating, based on the corresponding losses, the ML model by updating the plurality of model weights and the plurality of mask weights.

### CROSS-REFERENCE TO RELATED APPLICATIONS

This U.S. patent application claims priority under 35 U.S.C. § 119(e) to U.S. Provisional Application 63/719,189, filed on Nov. 12, 2024. The disclosure of this prior application is considered part of the disclosure of this application and is hereby incorporated by reference in its entirety.

### TECHNICAL FIELD

This disclosure relates to sparsity mask training using a top-k estimator.

### BACKGROUND

Sparsity is an important technique for making machine learning (ML) models more efficient. A sparse ML model is a type of model characterized by having a percentage of its weights (also called parameters) masked (e.g., intentionally set to zero), such that computations involving these weights need not be performed and are omitted. Accordingly, outputs of a sparse model can be computed using fewer resources and in less time. Sparse models are particularly useful in high-dimensional data scenarios (e.g., deep learning) where the number of features is large, as sparsity helps to reduce the complexity of the model, prevent overfitting, and enhance generalization to new data. Additionally, the reduced number of active weights makes the model easier to understand and interpret, as it highlights the most relevant variables contributing to the predictions.

The details of one or more implementations of the disclosure are set forth in the accompanying drawings and the description below. Other aspects, features, and advantages will be apparent from the description and drawings, and from the claims.

### SUMMARY

One aspect of the disclosure provides a computer-implemented method that when executed on data processing hardware causes the data processing hardware to perform operations that include obtaining training data including a plurality of training samples. Each training sample of the plurality of training samples includes a corresponding input and a corresponding ground-truth output. The operations also include obtaining a plurality of model weights of a machine learning (ML) model, obtaining a plurality of mask weights associated with the ML model, determining a sparsity mask based on the plurality of mask weights, and generating, by applying the sparsity mask to the plurality of model weights, a plurality of masked model weights. For each particular training sample of the plurality of training samples, the operations also include processing, using the ML model based on the plurality of masked model weights, the corresponding input to generate a predicted output, and determining a corresponding loss based on the corresponding ground-truth output and the predicted output. The operations also include updating, based on the corresponding losses, the ML model by updating the plurality of model weights and the plurality of mask weights.

Implementations of the disclosure may include one or more of the following optional features. In sone implementations, the operations further include deploying the ML model by: determining a sparsity mask based on the plurality of updated mask weights; generating, by applying the sparsity mask to the plurality of updated model weights, a plurality of masked model weights; and re-configuring the ML model as a sparse ML model based on a reduced number of model weights corresponding to non-masked weights of the plurality of masked model weights.

In some examples, determining the sparsity mask based on the plurality of mask weights includes: identifying the k-th largest mask weights of the plurality of mask weights; for each particular mask weight of the identified k-th largest mask weights, setting a corresponding value of a sparsity mask to a first pre-determined value; setting other values of the sparsity mask to a second pre-determined value; and determining the sparsity mask based on a stop gradient of the sparsity mask, the plurality of mask weights, and a stop gradient of the plurality of mask weights. In these examples, the first pre-determined value may be equal to one and the second pre-determined value may be equal to zero.

In other examples, determining the sparsity mask based on the plurality of mask weights includes: identifying the k-th largest mask weights of the plurality of mask weights; for each particular mask weight of the identified k-th largest mask weights, setting a corresponding value of a sparsity mask to the value of the particular mask weight; setting other values of the sparsity mask to a pre-determined value; and determining the sparsity mask based on a SoftMax of the sparsity mask and a size of the sparsity mask.

In some implementations, the plurality of model weights of the ML model are replicated across first and second layers of the ML model, the plurality of mask weights include a first plurality of mask weights associated with the first layer of the ML model, and the plurality of masked model weights include a first plurality of masked model weights. In these implementations, the operations may also include obtaining a second plurality of mask weights associated with the second layer of the ML model, determining a second sparsity mask based on the second plurality of mask weights, and generating, by applying the second sparsity mask to the plurality of model weights, a second plurality of masked model weights. Here, processing, using the ML model, the corresponding input may include using the first plurality of masked model weights for the first layer of the ML model and the second plurality of masked model weights for the second layer of the ML model, while updating, based on the corresponding losses, the ML model may include updating the first plurality of mask weights, the second plurality of mask weights, and the plurality of model weights. Additionally, the operations may also include deploying MI model by: determining a first sparsity mask based on the updated first plurality of mask weights; generating, by applying the first sparsity mask to the updated plurality of weights, a first plurality of masked model weights; determining a second sparsity mask based on the updated second plurality of mask weights; generating, by applying the second sparsity mask to the updated plurality of model weights, a second plurality of masked model weights; and re-configuring the ML model as a sparse ML model based on: a reduced number of weights for the first layer corresponding to non-zero weights of the first plurality of masked model weights; and a reduced number of weights for the second layer corresponding to non-zero weights of the second plurality of masked model weights.

Generating the plurality of masked model weights may include component-wise applying the sparsity mask to the plurality of model weights to generate the plurality of masked model weights. Updating, based on the corresponding losses, the ML model may include backpropagating the losses through the plurality of mask weights and the plurality of model weights. The ML model may include an automatic speech recognition (ASR) model, a text-to-speech (TTS) model, a language model, a sequence processing neural network model, or a text generation model. The operations may further include initializing the plurality of mask weights with random values.

Another aspect of the disclosure provides a system that includes data processing hardware and memory hardware storing instructions that when executed on the data processing hardware causes the data processing hardware to perform operations that include obtaining training data including a plurality of training samples. Each training sample of the plurality of training samples includes a corresponding input and a corresponding ground-truth output. The operations also include obtaining a plurality of model weights of a machine learning (ML) model, obtaining a plurality of mask weights associated with the ML model, determining a sparsity mask based on the plurality of mask weights, and generating, by applying the sparsity mask to the plurality of model weights, a plurality of masked model weights. For each particular training sample of the plurality of training samples, the operations also include processing, using the ML model based on the plurality of masked model weights, the corresponding input to generate a predicted output, and determining a corresponding loss based on the corresponding ground-truth output and the predicted output. The operations also include updating, based on the corresponding losses, the ML model by updating the plurality of model weights and the plurality of mask weights.

This aspect of the disclosure may include one or more of the following optional features. In some implementations, the operations also include deploying the ML model by: determining a sparsity mask based on the plurality of updated mask weights; generating, by applying the sparsity mask to the plurality of updated model weights, a plurality of masked model weights; and re-configuring the ML model as a sparse ML model based on a reduced number of model weights corresponding to non-masked weights of the plurality of masked model weights.

In some examples, determining the sparsity mask based on the plurality of mask weights includes: identifying the k-th largest mask weights of the plurality of mask weights; for each particular mask weight of the identified k-th largest mask weights, setting a corresponding value of a sparsity mask to a first pre-determined value; setting other values of the sparsity mask to a second pre-determined value; and determining the sparsity mask based on a stop gradient of the sparsity mask, the plurality of mask weights, and a stop gradient of the plurality of mask weights. In these examples, the first pre-determined value may be equal to one and the second pre-determined value may be equal to zero.

In other examples, determining the sparsity mask based on the plurality of mask weights includes: identifying the k-th largest mask weights of the plurality of mask weights; for each particular mask weight of the identified k-th largest mask weights, setting a corresponding value of a sparsity mask to the value of the particular mask weight; setting other values of the sparsity mask to a pre-determined value; and determining the sparsity mask based on a SoftMax of the sparsity mask and a size of the sparsity mask.

In some implementations, the plurality of model weights of the ML model are replicated across first and second layers of the ML model, the plurality of mask weights include a first plurality of mask weights associated with the first layer of the ML model, and the plurality of masked model weights include a first plurality of masked model weights. In these implementations, the operations may also include obtaining a second plurality of mask weights associated with the second layer of the ML model, determining a second sparsity mask based on the second plurality of mask weights, and generating, by applying the second sparsity mask to the plurality of model weights, a second plurality of masked model weights. Here, processing, using the ML model, the corresponding input may include using the first plurality of masked model weights for the first layer of the ML model and the second plurality of masked model weights for the second layer of the ML model, while updating, based on the corresponding losses, the ML model may include updating the first plurality of mask weights, the second plurality of mask weights, and the plurality of model weights. Additionally, the operations may also include deploying ML model by: determining a first sparsity mask based on the updated first plurality of mask weights; generating, by applying the first sparsity mask to the updated plurality of weights, a first plurality of masked model weights; determining a second sparsity mask based on the updated second plurality of mask weights; generating, by applying the second sparsity mask to the updated plurality of model weights, a second plurality of masked model weights; and re-configuring the ML model as a sparse ML model based on: a reduced number of weights for the first layer corresponding to non-zero weights of the first plurality of masked model weights; and a reduced number of weights for the second layer corresponding to non-zero weights of the second plurality of masked model weights.

Generating the plurality of masked model weights may include component-wise applying the sparsity mask to the plurality of model weights to generate the plurality of masked model weights. Updating, based on the corresponding losses, the ML model may include backpropagating the losses through the plurality of mask weights and the plurality of model weights. The ML model may include an automatic speech recognition (ASR) model, a text-to-speech (TTS) model, a language model, a sequence processing neural network model, or a text generation model. The operations may further include initializing the plurality of mask weights with random values.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of an example system including a sparse automatic speech recognition (ASR) model trained using a top-k estimator.

FIG. 2 is a schematic view of an example sparsity mask training process using a top-k estimator.

FIG. 3 is a flowchart of an example arrangement of operations for a computer-implemented method for performing sparsity mask training process using a top-k estimator.

FIG. 4 is a schematic view of an example computing device that may be used to implement the systems and methods described herein.

Like reference symbols in the various drawings indicate like elements.

### DETAILED DESCRIPTION

Sparsity is an important technique for making machine learning (ML) models more efficient. A sparse ML model is a type of model characterized by having a percentage of its weights (also called parameters) masked (e.g., intentionally set to zero), such that computations involving these weights need not be performed and are omitted. Accordingly, outputs of a sparse model can be computed using fewer resources and in less time. Sparse models are particularly useful in high-dimensional data scenarios (e.g., deep learning) where the number of features is large, as sparsity helps to reduce the complexity of the model, prevent overfitting, and enhance generalization to new data. Additionally, the reduced number of active weights makes the model easier to understand and interpret, as it highlights the most relevant variables contributing to the predictions. Past methods to train sparse models use magnitude-based pruning to simply remove the weights with the lowest magnitudes. However, such methods have limitations, such as challenges in optimization, under-utilization of important low-value parameters, and inability to customize weights for repeated layers. Accordingly, there is a need for improved methods for training a sparse ML model.

Implementations herein are directed toward using a top-k estimator during training of a sparse ML model to separate mask weight and model weight learning and, thus, leads to better sparse model performance. Here, the mask weights and model weights are learned separately, which untangles any potentially conflicting optimizations. Using the top-k estimator also allows low-magnitude model weights to be boosted or promoted during training. In some examples, the top-k estimator includes a binary top-k estimator. In other examples, the top-k estimator includes a probability mask top-k estimator. Top-k estimators are known to outperform magnitude-based pruning across a variety of sparsity levels (i.e., the percentage model weights that are pruned), constraints, and model size. Notably, top-k estimator especially outperform magnitude-based pruning at higher sparsity levels (e.g., 80% of weights pruned). Furthermore, when a layer is used several times (e.g., 8 times) in a model, the model weights for each replicated layer may be individually customized using top-k estimators, which may lead to even further enhancements in performance and lower complexity. Specifically, implementations disclosed herein are directed toward customizing each replicated layer even though model weights of a base model are identical by generating unique mask weights and a unique mask for each replicated layer.

While the present disclosure revolves around sparsity training an ML model that includes an automatic speech recognition (ASR) model, the ASR model is used for example only and the techniques disclosed herein for sparsity mask learning using top-k estimators may similarly be used for training any type of sparse ML model without departing from the scope of the present disclosure. For instance, the ML may also include a sequence processing neural network model, a large language model (LLM), a generative artificial intelligent (AI) model, a text-to-speech (TTS) model, a natural language processing (NLP) model, an image recognition model, a natural language understanding (NLU) model, or a text generation model.

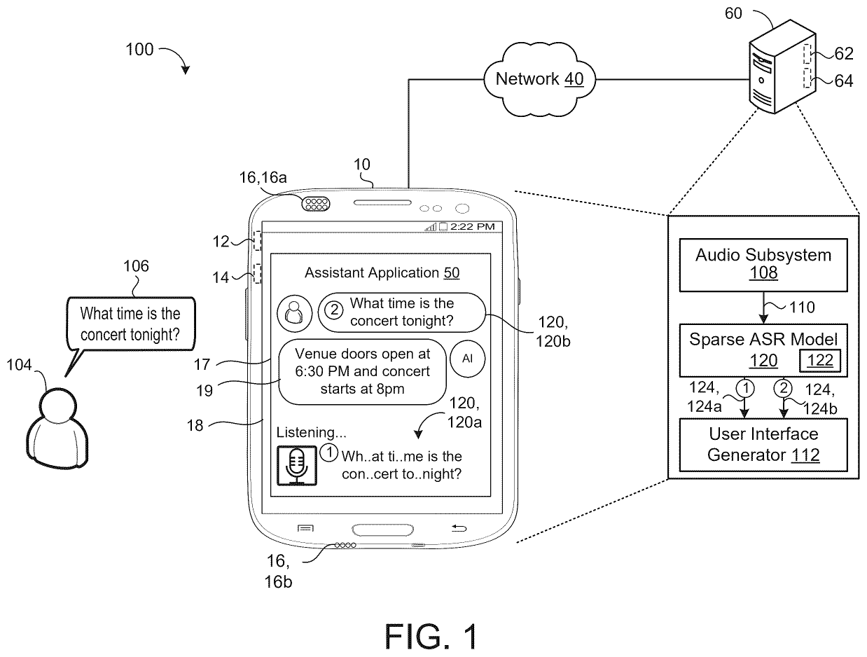

FIG. 1 is a schematic view of an example system 100 that includes a user 104 interacting with a user device 10 through voice input. The user device 10 (also referred to generally as a user device 10) is configured to capture sounds (e.g., streaming audio data 110) from the user 104 within the system 100. Here, the streaming audio data 110 may refer to, or represent, an utterance 106 spoken by the user 104 that functions as an audible query, a command for the user device 10, or an audible communication captured by the user device 10. Speech-enabled systems of the user device 10 may field the query or the command by answering the query and/or causing the command to be performed/fulfilled by one or more downstream applications.

The user device 10 may correspond to any computing device associated with the user 104 and capable of receiving audio data. Some examples of user devices 10 include, but are not limited to, mobile devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions that, when executed by the data processing hardware 12, cause the data processing hardware 12 to perform one or more operations. The user device 10 further includes an audio system 16 with an audio capture device 16a (e.g., a microphone) for capturing and converting the utterances 106 into electrical signals and a speech output device 16b (e.g., a speaker) for communicating with an audible audio signal (e.g., as output data from the user device 10). The user device 10 may implement an array of audio capture devices 16a without departing from the scope of the present disclosure, whereby one or more capture devices 16a in the array may not physically reside on the user device 10 but may be in communication with the audio system 16.

The system 100 includes an automated speech recognition (ASR) model 120 that resides on the user device 10 of the user 104 and/or on a remote computing system 60 (e.g., one or more remote servers of a distributed system executing in a cloud-computing environment) in communication with the user device 10 via a network 40. The remote computing system 60 may include physical and/or virtual (e.g., cloud based) resources, such as data processing hardware 62 (e.g., remote servers or CPUs) and/or memory hardware 64 (e.g., remote databases or other storage hardware). The memory hardware 64 is in communication with the data processing hardware 62 and stores instructions that, when executed by the data processing hardware 62, cause the data processing hardware 62 to perform one or more operations.

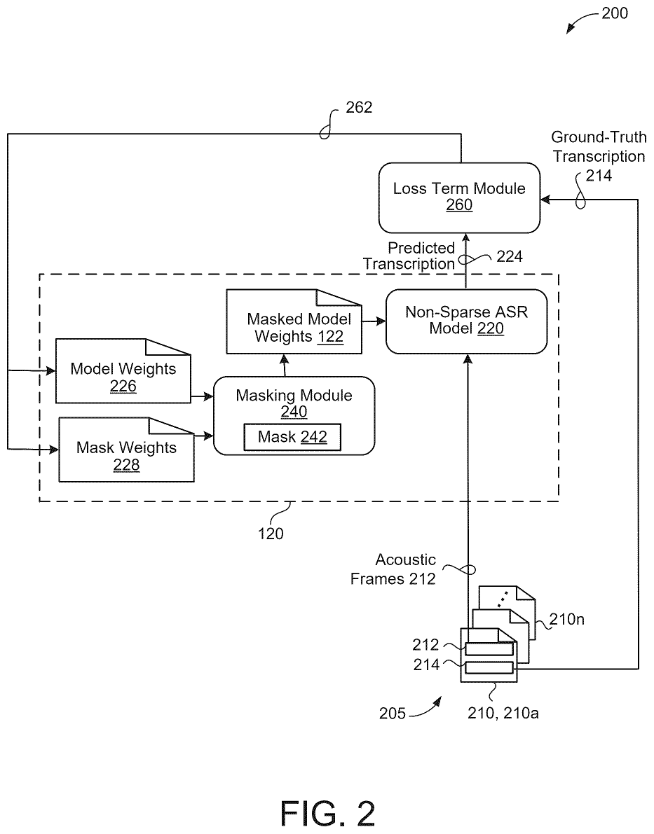

Referring to FIGS. 1 and 2, the ASR model 120 is a sparse machine learning (ML) model that includes a plurality of masked model weights 1i2. The masked model weights 122 are determined by a masking module 240, using a sparsity mask 242, from a plurality of model weights 226. Here, the plurality of masked model weights 122 represent, or include, a reduced number of model weights compared to the model weights 226, and the sparsity mask 242 is determined based on a plurality of mask weights 228.

In the illustrated example, the sparse ML (e.g., ASR) model 120 is generated by re-configuring a trained non-sparse ML (e.g., ASR) model 220 as the sparse ML model 120 based on a reduced number of model weights corresponding to non-masked or non-zero model weights of the plurality of masked model weights 122. Here, the non-sparse ML model 220 is trained using a full complement or set of model weights 226 and is then re-configured as the sparse ML model 120. In particular, the sparse ML model 120 may be deployed by determining a sparsity mask 242 based on a plurality of mask weights 228, and generating, by applying the sparsity mask 242 to a plurality of model weights 226 for the non-sparse ML model 220, the plurality of masked model weights 122. The non-sparse MIL model 220 is then re-configured as the sparse ML model 120 based on a reduced number of model weights corresponding to non-masked or non-zero weights of the plurality of masked model weights 122. Here, during deployment of the sparse ML model 120 trained using any of the top-k techniques disclosed herein, the model weights 226 and the mask weights 228 used to generate the final plurality of masked model weights 122 may be discarded such that there is no additional memory overhead in non-weight sharing settings.

In weight sharing scenarios (i.e., when a layer and its model weights are replicated within a model), the top-k estimator may maintain unique mask weights 228 for each replicated layer, thereby, providing customized masked model weights 122 for each replicated layer. In particular, when a layer of a model and its associated model weights 226 are replicated within the model, the model may be deployed by determining a first mask 242 based on a first plurality of mask weights 228 trained for a first replicated layer, and generating, by applying the first sparsity mask 242 to the replicated model weights 226, a first plurality of masked model weights 122 trained for the first replicated layer. A second sparsity mask 242 for a second replicated layer may determined based on a second plurality of mask weights 228 trained for the second replicated layer. The second mask 242 by be applied to the replicated model weights 226 to generate a second plurality of masked model weights 122 for the second replicated layer. The non-sparse ML model 220 may then be re-configured as the sparse ML model 120 based on a reduced number of weights for the first replicated layer corresponding to non-masked or non-zero weights of the first plurality of masked model weights 122, and a reduced number of weights for the second replicated layer corresponding to non-masked or non-zero weights of the second plurality of masked model weights 122. However, this customization may come with memory tradeoffs, as it requires transferring binary mask weights 228 for each replicated layer from disk to device memory, adding overhead for performance gains. Moreover, the top-k probability mask technique may be more expensive in weight sharing settings due to the need to transfer non-binary (e.g., floating point) mask weights 228.

In some examples, determining the masked model weights 122 includes identifying the k-th largest mask weights 228 of the plurality of mask weights 228, and, for each particular mask weight 228 of the identified k-th largest mask weights 228, setting a corresponding value of a sparsity mask 242 to a first pre-determined value (e.g., one), while other values of the sparsity mask 242 are set to a second pre-determined value (e.g., zero). The sparsity mask 242 is then determined based on a stop gradient of the sparsity mask 242, the plurality of mask weights 228, and a stop gradient of the plurality of mask weights 228.

In other examples, determining the masked model weights 122 includes identifying the k-th largest mask weights 228 of the plurality of mask weights 228 and, for each corresponding mask weight of the identified k-th largest mask weights, setting a corresponding value of a sparsity mask 242 to the value of the particular mask weight 228, while other values of the sparsity mask 242 are set to a pre-determined value (e.g., zero). The sparsity mask 242 is then determined based on a Softmax of the sparsity mask 242 and a size of the sparsity mask 242.

The user device 10 and/or the remote computing system 60 also includes an audio subsystem 108 configured to receive the utterance 106 spoken by the user 104 and captured by the audio capture device 16a, and to convert the utterance 106 into a corresponding digital format associated with input acoustic frames 110 capable of being processed by the ASR model 120. In the example shown, the user 104 speaks a respective utterance 106 and the audio subsystem 108 converts the utterance 106 into a corresponding sequence of acoustic frames 110 for input to the ASR model 120. Thereafter, the ASR model 120 receives, as input, the sequence of acoustic frames 110 corresponding to the utterance 106 and generates or predicts a corresponding transcription 124 (e.g., speech recognition result/hypothesis) of the utterance 106 as the ASR model 120 receives (e.g., processes) each acoustic frame 110 in the sequence of acoustic frames 110.

In the example shown, the ASR model 120 may perform streaming speech recognition to produce an initial speech recognition result 124, 124a and generate a final speech recognition result 124, 124b by improving the initial speech recognition result 124a. The speech recognition results 124 may either correspond to a partial speech recognition result or an entire speech recognition result. Stated differently, the speech recognition result 124 may either correspond to a portion of an utterance 106 or an entire utterance 106. For example, the partial speech recognition result may correspond to a portion of a spoken utterance or even a portion of a spoken term. However, as will become apparent, the ASR model 120 may perform additional processing on the final speech recognition result 124b whereby the final speech recognition result 124b may be delayed from the initial speech recognition result 124a.

The user device 10 and/or the remote computing system 60 also executes a user interface generator 112 configured to present a representation of the transcription 124 of the utterance 106 to the user 104 of the user device 10. As described in greater detail below, the user interface generator 112 may display the initial speech recognition results 124a in a streaming fashion during time 1 and subsequently display the final speech recognition results 124b in a streaming fashion during time 2. In some configurations, the transcription 124 output from the ASR model 120 is processed, for example, by an NLU or NLP module executing on the user device 10 or the remote computing system 60, to execute a user command/query specified by the utterance 106. Additionally, or alternatively, a text-to-speech system (not shown) (e.g., executing on any combination of the user device 10 or the remote computing system 60) may convert the transcription 124 into synthesized speech for audible output by the user device 10 and/or another device. In some examples, the sparse ML model 120 includes speech-text sequence processing neural network (e.g., a LLM) capable of performing speech recognition or speech translation on incoming audio.

In the example shown, the user 104 interacts with a digital assistant application 50 or another program of the user device 10 that uses the ASR model 120. For instance, FIG. 1 depicts the user 104 communicating with the digital assistant application 50 and the digital assistant application 50 displaying a digital assistant interface 17 on a screen 18 of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio subsystem 108 of the user device 10. In this example, the audio subsystem 108 receives the spoken utterance 106 and converts it into a sequence of acoustic frames 110 for input to the ASR model 120.

In the example shown in FIG. 1, the digital assistant application 50 may respond to the question posed by the user 104 using NLP or NLU. NLP/NLU generally refer to a process of interpreting written language (e.g., the initial speech recognition result 124a and/or the final speech recognition result 124b) and determining whether the written language prompts any action. In this example, the digital assistant application 50 uses NLP/NLU to recognize that the question 106 from the user 104 regards the user's schedule and more particularly a concert on the user's schedule. By recognizing these details with NLP/NL U, the automated assistant returns a response 19 to the user's query where the response 19 states, “Venue doors open at 6:30 PM and concert starts at 8 pm.” In some configurations, NLP/NLU occurs on the remote computing system 60 in communication with the data processing hardware 12 of the user device 10. In some examples, the sparse ML model 120 is capable of transcribing speech into text and also performing the function of the digital assistant application 50 by performing query interpretation on the transcribed speech and generating a suitable response. In these examples, the sparse ML model 120 may also exhibit text-to-speech capabilities by converting a textual representation of the response into a synthetic speech representation which may be converted into a time-domain audio waveform by a vocoder for audibly conveying the response from the user device 10.

FIG. 2 is a schematic view of an example sparsity mask training process 200 for training a sparse ML model 120, such as the sparse ASR model 120, using a top-k estimator. The training process 200 may execute on the remote computing system 60 (i.e., on the data processing hardware 62) or on the user device 10 (i.e., on the data processing hardware 12). The training process 200 overcomes limitations of magnitude pruning, by introducing and training dedicated mask weights 228 in addition to model weights 226. Here, the mask weights 228 are used to determine whether to prune a corresponding model weight 226. In particular, let M denote a set of mask weights 228 that may, for example, be randomly initialized, W denote a set of jointly learned model weights 226, and S_{H}(W, M) denote a top-k estimator sparsity mask generation function, which will use the mask weights M 228 to determine a sparsity mask 242 for the model weights W 226 based on constraints H. An example objective function for training the sparse ASR model 120 may be expressed as:

$${min}_{{S}_{H} ( W , M )} {𝔼}_{x , y \sim D} ℒ ( f ( x : {S}_{H} ( W , M ) ) , y ) \qquad EQN ( 1 )$$

The training process 200 provides multiple advantages including, for example, decreasing update conflicts and optimization difficulties based on the capability of the mask weights M 228 and the model weights W 226 to evolve independently. Moreover, a model weight 226 with a low magnitude can still receive sufficient updates during training, as masking decisions are no longer tied to its magnitude. As a result, small model weights 226 can grow even if their corresponding mask weight 228 is inactive. Further still, sparsity masks 242 can be customized for each replicated layer of a model by training dedicated mask weights 228 for each replicated layer. This allows for increases in repetitions, which maximizes benefits from transformations customized by sparsity patterns.

The training process 200 leverages a non-sparse ML model 220 (e.g., non-sparse ASR model) to train a sparse ML model 120 using a top-k estimator generator function S_{H}(W, M). In this example, the training process 200 also leverages a masking module 240 for determining masked model weights 122 for the non-sparse ML model 220 based on the model weights 226 and the mask weights 228. Here, the model weights 226 represent a full complement of model weights for the non-sparse ML model 220, while the masked model weights 122 represent a reduced set of model weights 122 for the sparse ML model 120. In weight sharing scenarios (i.e., when a layer and its base model weights are replicated in a model), the training process 200 may be used to train unique mask weights 228 for each replicated layer, ensuring customized model weights 122 for each replicated layer.

The training process 200 trains the model 120 using training data 205 that includes a plurality of training samples 210. Here, each training sample 210 of the plurality of training samples 210 includes a corresponding input 212 (i.e., a corresponding sequence of acoustic frames 212) characterizing a corresponding training utterance, and a corresponding ground-truth output 214 (i.e., a corresponding ground-truth transcription 214) of the corresponding training utterance.

The training process 200 obtains a plurality of current trained model weights 226 of the non-sparse ML model 220 and obtains a plurality of trained mask weights 228 associated with the non-sparse ML model 220. A masking module 240 then determines a sparsity mask 242 based on the plurality of mask weights 228, and generates, by applying the sparsity mask 242 to the plurality of model weights 226, the plurality of masked model weights 122.

In some examples, the masking module 240 determines a binary sparsity mask B 242 using a top-k binary-mask generator function 5_{H}(W, M) Here, the training process 200 applies magnitude pruning on the mask weights M 228 to determine a binary sparsity mask B 242 and applies the binary sparsity mask B 242 to the model weights W 226 to get the masked model weights Ŵ 122. In particular, let t_{bin} be the smallest magnitude weight in the mask weights M 228 that is greater than H percentage of the weights in the mask weights M 228. Each cell B_{i,j} in the binary sparsity mask B 242 may be expressed as:

$${B}_{i , j} = \{ \begin{matrix}0 if \vert {M}_{i , j} \vert \leq {t}_{bin} \\ 1 if \vert {M}_{i , j} \vert > {t}_{bin}\end{matrix} \qquad EQN ( 2 )$$

The masked model weights Ŵ 122 may be expressed as:

$$\hat{W} = W ⊙ ( SG ( \hat{B} ) + M - S G ( M ) ) \qquad EQN ( 3 )$$

where SG [symbol] denotes a stop gap function, and ⊙ is a component-wise multiplication. In EQN (2), B_{i,j} may be set to other pre-determined values other than one and zero. Here, the training process 200 adapts the mask weights M 228 using gradients generated using the masked model weights Ŵ 122.

In other examples, the masking module 240 determines a probability sparsity mask T 242 using a top-k probability-mask generator function S_{H}(W, M). Here, for example, each individual mask weight M 228 is considered an expert of an entire matrix of mask weights M 228 that is considered as a collection of experts for a mixture-of-experts (MoE) method. Dedicated mask weights M 228 act as router parameters, and the training process 200 generates a probability sparsity mask T 242 that is multiplied with the actual model weights W 226 to produce the masked model weights Ŵ 122. This probability sparsity mask T 242 contains zeros for pruned masked model weights Ŵ 122 and re-normalized weights for unpruned masked model weights Ŵ 226. Here, the training process 200 works to determine which of the original model weights W 226 should be kept and which should be pruned. In particular, let T denote the top-k weights from the model weights W 226, where k corresponds to the number of model weights W 226 to retain based on a pruning probability H. Let t_{prob} denote the smallest H weights in the model weights W 226. Each cell [symbol] in the probability sparsity matrix T may be expressed as:

$${T}_{i , j} = \{ \begin{matrix}0 if \vert {M}_{i , j} \vert \leq {t}_{prob} \\ {M}_{i , j} if \vert {M}_{i , j} \vert > {t}_{prob}\end{matrix} \qquad EQN ( 4 )$$

The training process 200 then applies a Softmax operation along the entire probability sparsity matrix T 242 and scales the output of the Softmax operation based on the number of unpruned model weights to obtain masked model weights Ŵ 122. The masked model weights Ŵ 122 may then be expressed as:

$$\hat{W} = Softmax ( T ) * size ( T ) \qquad EQN ( 5 )$$

For each training sample 210 in the training data 205, the training process 200 processes, using the non-sparse ML model 220 based on the plurality of masked model weights Ŵ 122, the corresponding input 212 to generate a predicted output 224, and a loss term module 260 determines a corresponding loss 262 based on the corresponding ground-truth output 214 and the predicted output 224. Here, the loss term module 260 may determine the loss 262 using any loss function, such as, but not limited to, a negative log of the prediction probability for the predicted transcription 224, a number of word part errors, or a number of word errors.

Thereafter, the training process 200 trains the model weights W 226 and the mask weights M 228 to teach the non-sparse ML model 220 to reduce the losses 262. In some examples, the training process 200 trains the model weights W 226 and the mask weights M 228 by adjusting, adapting, updating, fine-tuning, etc. the model weights W 226 and the mask weights M 228 by, for example, backpropagating the losses 262 through the model weights W 226 and the mask weights M 228.

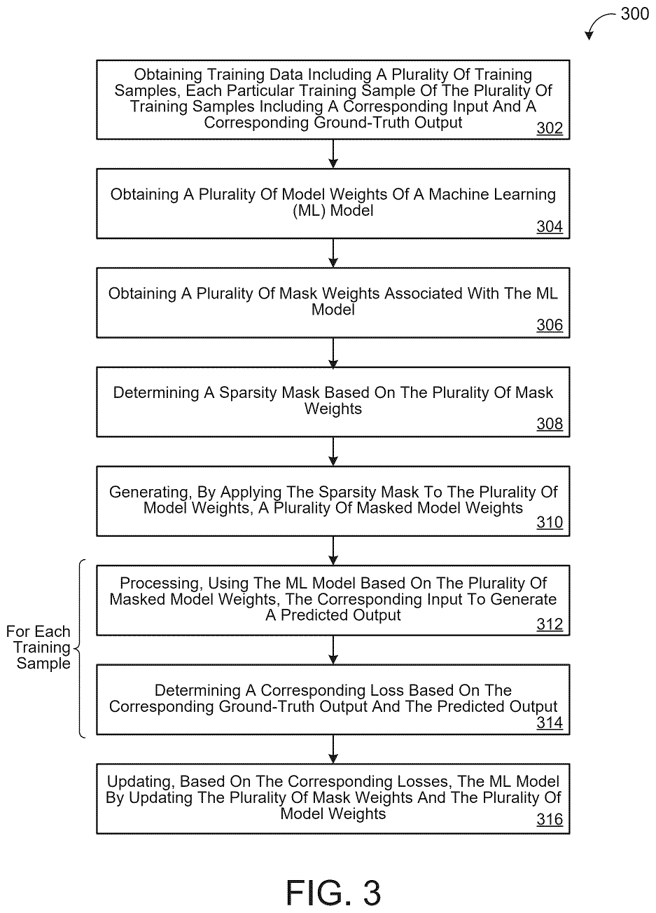

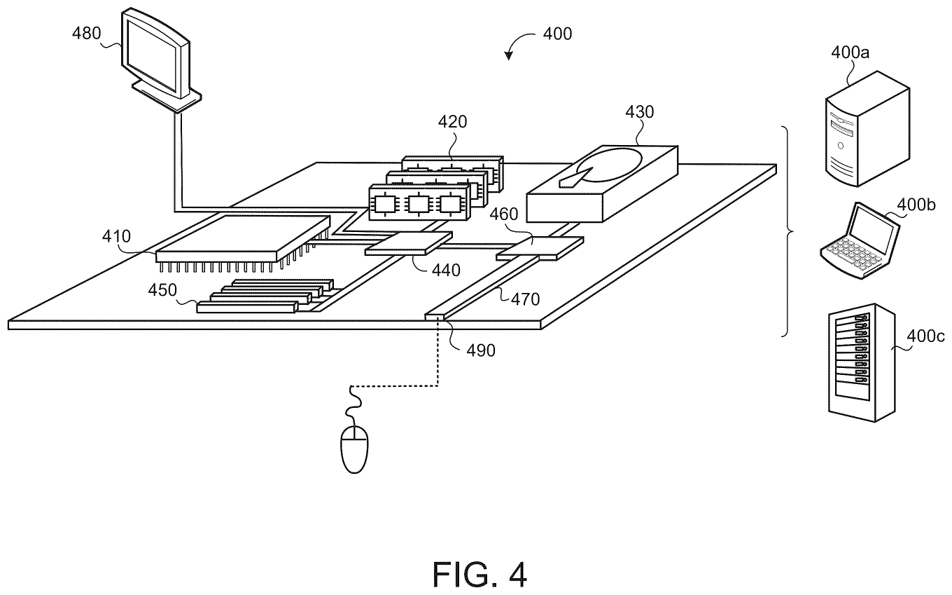

FIG. 3 is a flowchart of an exemplary arrangement of operations for a computer-implemented method 300 for performing a sparsity mask training process using a top-k estimator. The operations may be performed by data processing hardware 410 (FIG. 4) (e.g., the data processing hardware 12 of the user device 10 or the data processing hardware 62 of the remote computing system 60) based on executing instructions stored on memory hardware 420 (e.g., the memory hardware 14 of the user device 10 or the memory hardware 64 of the remote computing system 60).

At operation 302, the method 300 includes obtaining training data 205 including a plurality of training samples 210. Each training sample 210 of the plurality of training samples 210 includes a corresponding input 212 and a corresponding ground-truth output 214. At operation 304, the method 300 includes obtaining a plurality of model weights W 226 of a non-sparse machine learning (ML) model 220. At operation 306, the method 300 includes obtaining a plurality of mask weights H 228 associated with the ML model 220.

At operation 308, the method 300 includes determining a sparsity mask 242 based on the plurality of mask weights M 228. The sparsity mask 242 may include a binary sparsity mask B or a probability sparsity mask T. At operation 310, the method 300 includes generating, by applying the sparsity mask 242 to the plurality of model weights W 226, a plurality of masked model weights Ŵ 122.

At operation 310, for each training sample 210 of the plurality of training samples 210, the method 300 includes processing, using the ML model 220 based on the plurality of masked model weights Ŵ 122, the corresponding input 212 to generate a predicted output 224. At operation 312, the method 300 includes determining a corresponding loss 262 based on the corresponding ground-truth output 214 and the predicted output 224. At operation 314, the method 300 includes updating, based on the corresponding losses 262, a sparse ML model 120 by updating the plurality of mask weights M 228 and the plurality of model weights W 226.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 62, memory 420 (i.e., memory hardware) that can be used to implement the memory hardware 14 and/or 64, a storage device 430 (i.e., memory hardware) that can be used to implement the memory hardware 14 and/or 64, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining training data comprising a plurality of training samples, each training sample of the plurality of training samples comprising a corresponding input and a corresponding ground-truth output;
obtaining a plurality of model weights of a machine learning (ML) model;
obtaining a plurality of mask weights associated with the ML model;
determining a sparsity mask based on the plurality of mask weights;
generating, by applying the sparsity mask to the plurality of model weights, a plurality of masked model weights;
for each training sample of the plurality of training samples:
processing, using the ML model based on the plurality of masked model weights, the corresponding input to generate a predicted output; and
determining a corresponding loss based on the corresponding ground-truth output and the predicted output; and
updating, based on the corresponding losses, the ML model by updating the plurality of model weights and the plurality of mask weights.

2. The computer-implemented method of claim 1, wherein the operations further comprise deploying the ML model by:
determining a sparsity mask based on the plurality of updated mask weights;
generating, by applying the sparsity mask to the plurality of updated model weights, a plurality of masked model weights; and
re-configuring the ML model as a sparse ML model based on a reduced number of model weights corresponding to non-masked weights of the plurality of masked model weights.

3. The computer-implemented method of claim 1, wherein determining the sparsity mask based on the plurality of mask weights comprises:
identifying the k-th largest mask weights of the plurality of mask weights;
for each particular mask weight of the identified k-th largest mask weights, setting a corresponding value of a sparsity mask to a first pre-determined value;
setting other values of the sparsity mask to a second pre-determined value; and
determining the sparsity mask based on a stop gradient of the sparsity mask, the plurality of mask weights, and a stop gradient of the plurality of mask weights.

4. The computer-implemented method of claim 3, wherein the first pre-determined value is equal to one and the second pre-determined value is equal to zero.

5. The computer-implemented method of claim 1, wherein determining the sparsity mask based on the plurality of mask weights comprises:
identifying the k-th largest mask weights of the plurality of mask weights;
for each particular mask weight of the identified k-th largest mask weights, setting a corresponding value of a sparsity mask to the value of the particular mask weight;
setting other values of the sparsity mask to a pre-determined value; and
determining the sparsity mask based on a SoftMax of the sparsity mask and a size of the sparsity mask.

6. The computer-implemented method of claim 1, wherein generating, by applying the sparsity mask to the plurality of model weights, the plurality of masked model weights comprises component-wise applying the sparsity mask to the plurality of model weights to generate the plurality of masked model weights.

7. The computer-implemented method of claim 1, wherein:
the plurality of model weights of the ML model are replicated across first and second layers of the ML model;
the plurality of mask weights comprises a first plurality of mask weights associated with the first layer of the ML model; and
the plurality of masked model weights comprises a first plurality of masked model weights.

8. The computer-implemented method of claim 7, wherein the operations further comprise:
obtaining a second plurality of mask weights associated with the second layer of the ML model;
determining a second sparsity mask based on the second plurality of mask weights; and
generating, by applying the second sparsity mask to the plurality of model weights, a second plurality of masked model weights,
wherein:
processing, using the ML model, the corresponding input comprises using the first plurality of masked model weights for the first layer of the ML model and the second plurality of masked model weights for the second layer of the ML model; and
updating, based on the corresponding losses, the ML model comprises updating the first plurality of mask weights, the second plurality of mask weights, and the plurality of model weights.

9. The computer-implemented method of claim 8, wherein the operations further comprise deploying the ML model by:
determining a first sparsity mask based on the updated first plurality of mask weights;
generating, by applying the first sparsity mask to the updated plurality of weights, a first plurality of masked model weights;
determining a second sparsity mask based on the updated second plurality of mask weights;
generating, by applying the second sparsity mask to the updated plurality of model weights, a second plurality of masked model weights; and
re-configuring the ML model as a sparse ML model based on:
a reduced number of weights for the first layer corresponding to non-zero weights of the first plurality of masked model weights; and
a reduced number of weights for the second layer corresponding to non-zero weights of the second plurality of masked model weights.

10. The computer-implemented method of claim 1, wherein updating, based on the corresponding losses, the ML model comprises backpropagating the losses through the plurality of mask weights and the plurality of model weights.

11. The computer-implemented method of claim 1, wherein the ML model comprises an automatic speech recognition (ASR) model, a text-to-speech (TTS) model, a language model, a sequence processing neural network model, or a text generation model.

12. The computer-implemented method of claim 1, wherein the operations further comprise initializing the plurality of mask weights with random values.

13. A system comprising:
data processing hardware; and
memory hardware in communication with the data processing hardware, the memory hardware storing instructions that, when executed on the data processing hardware, cause the data processing hardware to perform operations that include:
obtaining training data comprising a plurality of training samples, each training sample of the plurality of training samples comprising a corresponding input and a corresponding ground-truth output;
obtaining a plurality of model weights of a machine learning (ML) model;
obtaining a plurality of mask weights associated with the ML model;
determining a sparsity mask based on the plurality of mask weights;
generating, by applying the sparsity mask to the plurality of model weights, a plurality of masked model weights;
for each training sample of the plurality of training samples:
processing, using the ML model based on the plurality of masked model weights, the corresponding input to generate a predicted output; and
determining a corresponding loss based on the corresponding ground-truth output and the predicted output; and
updating, based on the corresponding losses, the ML model by updating the plurality of model weights and the plurality of mask weights.

14. The system of claim 13, wherein the operations further comprise deploying the ML model by:
determining a sparsity mask based on the plurality of updated mask weights;
generating, by applying the sparsity mask to the plurality of updated model weights, a plurality of masked model weights; and
re-configuring the ML model as a sparse ML model based on a reduced number of model weights corresponding to non-masked weights of the plurality of masked model weights.

15. The system of claim 13, wherein determining the sparsity mask based on the plurality of mask weights comprises:
identifying the k-th largest mask weights of the plurality of mask weights;
for each particular mask weight of the identified k-tb largest mask weights, setting a corresponding value of a sparsity mask to a first pre-determined value;
setting other values of the sparsity mask to a second pre-determined value; and
determining the sparsity mask based on a stop gradient of the sparsity mask, the plurality of mask weights, and a stop gradient of the plurality of mask weights.

16. The system of claim 15, wherein the first pre-determined value is equal to one and the second pre-determined value is equal to zero.

17. The system of claim 13, wherein determining the sparsity mask based on the plurality of mask weights comprises:
identifying the k-th largest mask weights of the plurality of mask weights;
for each particular mask weight of the identified k-th largest mask weights, setting a corresponding value of a sparsity mask to the value of the particular mask weight;
setting other values of the sparsity mask to a pre-determined value; and
determining the sparsity mask based on a SoftMax of the sparsity mask and a size of the sparsity mask.

18. The system of claim 13, wherein generating, by applying the sparsity mask to the plurality of model weights, the plurality of masked model weights comprises component-wise applying the sparsity mask to the plurality of model weights to generate the plurality of masked model weights.

19. The system of claim 13, wherein:
the plurality of model weights of the ML model are replicated across first and second layers of the ML model;
the plurality of mask weights comprises a first plurality of mask weights associated with the first layer of the ML model; and
the plurality of masked model weights comprises a first plurality of masked model weights.

20. The system of claim 19, wherein the operations further comprise:
obtaining a second plurality of mask weights associated with the second layer of the ML model;
determining a second sparsity mask based on the second plurality of mask weights; and
generating, by applying the second sparsity mask to the plurality of model weights, a second plurality of masked model weights,
wherein:
processing, using the ML model, the corresponding input comprises using the first plurality of masked model weights for the first layer of the ML model and the second plurality of masked model weights for the second layer of the ML model; and
updating, based on the corresponding losses, the ML model comprises updating the first plurality of mask weights, the second plurality of mask weights, and the plurality of model weights.

21. The system of claim 20, wherein the operations further comprise deploying the ML model by:
determining a first sparsity mask based on the updated first plurality of mask weights;
generating, by applying the first sparsity mask to the updated plurality of weights, a first plurality of masked model weights;
determining a second sparsity mask based on the updated second plurality of mask weights;
generating, by applying the second sparsity mask to the updated plurality of model weights, a second plurality of masked model weights; and
re-configuring the ML model as a sparse ML model based on:
a reduced number of weights for the first layer corresponding to non-zero weights of the first plurality of masked model weights; and
a reduced number of weights for the second layer corresponding to non-zero weights of the second plurality of masked model weights.

22. The system of claim 13, wherein updating, based on the corresponding losses, the ML model comprises backpropagating the losses through the plurality of mask weights and the plurality of model weights.

23. The system of claim 13, wherein the M L model comprises an automatic speech recognition (ASR) model, a text-to-speech (TTS) model, a language model, a sequence processing neural network model, or a text generation model.

24. The system of claim 13, wherein the operations further comprise initializing the plurality of mask weights with random values.
